(19) United States
(12) Patent Application Publication
(10) Pub. No.: US 2014/0239074 A1
(43) Pub. Date: Aug. 28, 2014

(54) METHOD OF DESIGNING & MANUFACTURING AN ANTI-COUNTERFEITING RFID TAG, THE ANTI-COUNTERFEITING RFID TAG AND THE ANTI-COUNTERFEITING PACKAGE

(71) Applicant: Gang Wang, Beijing (CN)

(72) Inventor: Gang Wang, Beijing (CN)

(21) Appl. No.: 14/123,182

(22) PCT Filed: May 18, 2012
(86) PCT No.: PCT/CN2012/075767

§ 371 Date: Nov. 30, 2013

(30) Foreign Application Priority Data
Jun. 2, 2011 (CN) 201110147790.2

(51) Int. Cl. G06K 19/077

(52) U.S. Cl. CPC G06K 19/07798; G06K 19/0776; G06K 19/07786
USPC 235/488; 438/118

(57) ABSTRACT

The invention relates to a method of designing & manufacturing anti-counterfeiting RFID tags, the anti-counterfeiting RFID tags obtained and the anti-counterfeiting package related. The invention belongs to application of radio frequency identification technology. The tag design comprises an adopted folded dipole antenna form using fragile paper as antenna substrate board. Integrate antenna and fragile paper substrate board securely and firmly. In alignment with the central position of the chip overlay an “island”-type compound gasket on the bottom surface of fragile paper substrate, so that the antenna forms an arch spatial structure at the center position of the IC chip. Coating the fragile paper substrate surface with adhesive, then compounding with cover layer material which coated with release fragile film former. The sizes of surface material and adhesive are larger than that of the fragile paper substrate board. The tamper-evident anti-counterfeiting UHF RFID label achieved through this method can be read reliably on the metal surface. It can avoid or reduce the probability of accidental damage during label sticking and transportation and improve anti-counterfeiting performance effectively. This invention of designing and manufacturing method is ingenious, simple, inexpensive and of high capacity.

### TECHNOLOGY FIELD

The invention relates to application areas of radio frequency identification technology, especially relates to a method of designing & manufacturing a tamper-evident, and metal-surface-disturbance-resisted UHF RFID tags, relates to the anti-counterfeiting RFID tags obtained through this method, and to the anti-counterfeiting packages with these RFID tags built-in.

### BACKGROUND TECHNOLOGY

Radio frequency identification (the abbreviation RFID) technology has been widely using in logistics, retail industries and many other areas. It has improved management efficiency and saved labor costs significantly. A RFID system consists of a RFID tag(s) and a RFID reader(s). The work process is that the RFID reader generates electromagnetic wave at a particular frequency and sent through the mode of space coupling (also called sent request signals). When a RFID tag passes through within the RFID reader's scanning distance, it will detect the request signal and reverse scattering couple the electromagnetic wave back to the RFID reader (This is reply signal).

RFID technology has great potential in applications in anti-counterfeiting field. In industries such as liquor, tobacco and pharmacy, once counterfeit products emerge, they always bring an immeasurable loss to both the society and individuals. Safe and effective anti-counterfeiting measurements are need in product production and distribution fields in these industries. Paper-based print anti-counterfeiting technologies (such as laser mark and digital security code and so on) are not unique or exclusive. They are easy to be duplicated. It is difficult for them to play the role of real anti-counterfeiting. RFID anti-counterfeiting technology becomes superior in the industries mentioned above by its outstanding anti-counterfeiting capabilities. RFID anti-counterfeiting technology requires each passive RFID tag to be allocated to every protected subject. Each RFID tag has a globally unique ID number. And the ID number is stored in the read-only memory (ROM) of a chip so that they cannot be modified or copied. This greatly enhanced the anti-counterfeiting performance.

But in above mentioned liquor, tobacco or pharmaceutical industries the objects to be protected normally have small size and mostly are packed with foils or printed aluminum-plated paper boxes. If a common RFID tag is affixed onto such packaging surface, it is not readable effectively at all. Typically, the existing RFID technology adopts symmetric dipole antennas. Correspondingly RFID tags use antenna-chip-split type structure for the purpose of anti-counterfeiting. Jun. 20, 2007 published Chinese patent “ Liquor Anti-counterfeiting System and Method Based on RFID Technology,” Patent Application Number 200510126482.6, revealed such a split type anti-counterfeiting RFID tag, The antenna in that patent is located at the outside of the bottle while the chip is inside the bottle cap. The connection path between the antenna and the chip is realized by lead wires and solder joints (or attached metal bands). This method results in an anti-counterfeiting RFID tag with disadvantages of occupying too much space, complex structure, high manufacturing costs, vulnerable to damaging during packing and shipping, and so on. Some other patents reveal methods of putting RFID tags inside battle caps or affixing to the cap surfaces. But the fact that a product covered by outer package of aluminum foil causes the RFID tags to not be read effectively without opening the package. But breaking the package in such a case will devaluate the integrity and image of the product and eventually devaluate the performance of RFID anti-counterfeiting tags

UHF RFID tags communicate with readers in 900 MHz radio frequency range. A longer reading distance can be achieved. But metal and liquid environments have a serious negative impact on the performance of UHF RFID tags. Tags simply attached to the metal surface cannot communicate at all. Currently, in industries of food, beverages, pharmaceuticals, cigarettes and electrical appliances, aluminum foil and vacuum aluminum-plated paper materials are commonly used in packaging and printing. Therefore, common RFID tags cannot be used to realize anti-counterfeiting or sales channel management for unit product effectively. In addition, most of current anti-counterfeiting logo stickers are made of a fragile material which has the feature of destroyed-at-tear. It is hard to avoiding damages during pasting or transportation if such tags anti-counterfeiting tags are applied directly.

### Invention Content

The purpose of this invention is to provide a method of designing & manufacturing tamper-evident anti-counterfeiting UHF RFID labels which can be affixed to the surface of package materials containing metal components. The tamper-evident anti-counterfeiting UHF RFID label achieved through this method can be read reliably on the metal surface. It can avoid or reduce the probability of accidental damage during label sticking and transportation and improve anti-counterfeiting performance effectively. This invention of designing and manufacturing method is ingenious, simple, inexpensive and capable of high capacity.

The second objective of the invention is to provide tamper-evident anti-counterfeiting UHF RFID labels, which can be affixed to the surface of package materials containing metal components, through the designing and manufacturing method in the above invention.

The third objective of this invention is to disclose an RFID anti-counterfeiting package comprising of the above tamper-evident UHF RFID labels and labeled objects with metal surface.

These three objectives of this invention are realized through the following three schemes successively:

Technical solution of a designing and manufacturing method of tamper-evident metal-surface-disturbance-resistant UHF RFID tags comprising of the following steps:

(1) The tag antenna design using folded dipole antenna form.

(2) Using fragile paper as substrate board for antenna, integrating antenna and fragile paper substrate board securely and firmly to ensure the antenna and fragile materials will be broken and destroyed together when torn from their attached object.

(3) Placing IC chip in the middle of the power supply portion of folded symmetric dipole antenna to achieve electrical connection between the antenna and the chip.

(4) On the bottom surface of fragile paper substrate overlaying an “island”-type compound gasket, in alignment with the central position of the chip. The size of the compound gasket should be less than or equal to the size of fragile paper substrate so that when affixed to such a RFID tag to its labeled object the antenna will form an arch spatial structure in the center position of the chip.

(5) Coating the fragile paper substrate surface with adhesive, then compounding with cover layer material which coated with release fragile film former. The sizes of surface material and adhesive are larger than the fragile paper substrate board so that the surface material completely covers RFID antennas and chips, and leaves blank spaces around.

Obtained from the above method, the tamper-evident metal surface disturbance-resistance UHF RFID labels have compound structures. Successively from bottom to surface a compound structured RFID label includes adhesive bottom layer, “island” type compound gasket, fragile paper substrate board, folded dipole antenna & chip, adhesive layer and surface material. Antenna is integrated with fragile paper substrate board firmly and securely. Chip and antenna are connected electrically. “Island” type compound gasket is in alignment with the central position of chip. The size of compound gasket is less than or equal to the size of the fragile paper substrate board.

The anti-counterfeiting RFID technical solution in the present invention comprises the above mentioned tamper-evident metal surface disturbance-resistance UHF RFID tags and the metal surface objects labeled with such tags. The solution includes RFID tags with compound structures and the labeled objects. The mentioned RFID tags structured from bottom to surface as adhesive bottom layer, “island” type compound gasket, fragile paper substrate board, folded dipole antenna & chip, adhesive layer and surface material. Antenna is integrated with fragile paper substrate board firmly and securely. Chip and antenna are connected electrically. “Island” type compound gasket is in alignment with the central position of chip. The size of compound gasket is less than or equal to the size of the fragile paper substrate board. The above mentioned identically labeled object is covered by aluminum-plated paper and there is a slit on surface of the object. Attaching the entire RFID tags to the surface of the object in such a way that the dipole antenna structure of the tag is symmetrical about the slit and the chip is in alignment with the position of the slit.

The mentioned antenna structure design uses flake folded dipole, which including flake folded dipole conducts in center position and power supply conductors in two sides. The described flake folded dipole conductors connects with IC chip and makes a closed loop. The described power supply conductors are curve power loading poles. They electrically connect with the flake folded dipole conductors. The described flake folder dipole conductors are rectangular or circle. The mentioned power supply poles are designed as multiple pairs. Each pair is set symmetrically about the flake folded dipole conductors.

On the outside of the mentioned tag surface material, print a straight line as a mark for easy affixing the tags to the surface of package at the precise position of the slit.

As a further strengthening anti-counterfeiting measure, in mentioned antenna layer there is a die-cutting edge line. To tear it (label) up will inevitably damage the electrical connection between the chip and the antenna then result in failure of tag. This measure is a prevention of counterfeit or reusing.

The RFID tag in the present invention adopts folded dipole antenna. The miniaturization of this antenna structure makes tags can be applied better on the surfaces of small size labeled objects. Antenna choices include metal wire, metal foil, printed wires or other conventional forms. Material options include silver, aluminum, copper or other conventional conductors. Use existing technology, such as printing, vacuum coating, laminating or other conventional methods to integrate antenna and fragile paper as long as guaranteeing antenna and fragile paper will break and damage together when being torn up from labeled object that they are attached to. Fragile paper is a marketing available material, belonging to existing technology. Being selected to make RFID tag substrate board, fragile material has a feature of damaged-at-tear up. Using existing technologies such as ACP conductive adhesive flip chip bonding, strap bonding or wire bonding realizes direct electrical connection between chip and RFID antennas. Further improvement is to protect and enhance electrical connection part between chip and the mentioned RFID antenna with UV glue or like materials. Across substrate board, placed is a gasket under the chip to form a partial projecting “island” structure. The metal antenna forms an arched spatial structure in the central position where the chip located. This is the key technology solution to make UHF band RFID tags adapt to metal surface environment. Acting as a protecting role, tag's surface material can be various kinds of thin material such as polyethylene terephthalate (PET) or paper. When being attached to product package surfaces, the tag's surface material plays key protection function. Due to the larger size of the surface material than fragile paper substrate board, the surface material can cover RFID antenna and chip completely. It supplies complete protection, effectively prevents RFID antenna and chip from damaging under normal circumstances and avoids breaking antenna by forced stretching. This design is simple and ingenious, and achieves extremely significant result. For further strengthening anti-counterfeiting effect, print anti-counterfeiting patterns on the inside part of the surface material. Any attempt to split anti-counterfeiting RFID tags from labeled objects surface will cause the surface materials to fall off RFID tags surface and leave anti-counterfeiting patterns damage marks which indicate that the tags has been used.

For easy store and transport, coat the bottom side of fragile paper substrate with adhesive and attach release paper. The adhesive fixes the “island”-type compound gasket in the appointed position on the tag substrate board. And the release paper protects fragile paper substrates at the same time. When a RFID tag is attached to a labeled object, just peel the release paper at the bottom and affix the RFID tag directly to the object surface. The package to be identified is covered by aluminum-plated paper, with a slit on it. An anti-counterfeiting RFID tag obtained from present invention adhesive to the package and its chip is in alignment with the slit position forms the anti-counterfeiting packaging of this invention. Manufacturers receive these anti-counterfeiting packages, put them into products and then just need to seal and active RFID tags. When a consumer opens the package, the RFID label will be torn up from the slit, thus destroying the anti-counterfeiting RFID label at the same time. Passive UHF FRID tags obtained through the present invention are particularly suitable to apply to labeled objects in food, liquor, beverage, medicine, cigarettes and electrical appliance industries. Foil or vacuum aluminum-plated materials are widely used for packing and printing for these labeled objects. This invention realizes unit management efficiently and prevention of forgery or unauthorized distribution.

Compare with metal surface disturbance-resistant RFID tags from existing technologies which adopt specially designed rigid antenna, the RFID tags obtained from the present invention uses appropriate thickness of single layer or multi layers fragile material as antenna electric media. Its compound tag structure is composed of outer surface material, electric media layer (bonding IC chip and antenna), ‘island’ type compound gasket, and adhesive. By simplifying the structure, more flexible metal surface disturbance-resistant RFID tags with tamper-evident feature are generated. It integrates a variety of anti-counterfeiting technologies and has excellent anti-forgery performance. The usage of surface layer material protects the fragile paper tags effectively. Massive and mechanized production is realized and costs reduced.

In the present invention, the anti-counterfeiting RFID package has antenna-IC chip-integrated RFID tag implanted in advance and seals the RFID tag in the package. It reduces overall costs. It reduces the difficulty of implementation for manufacturers which can help to minimize the possibility of accidental damages in production plants when affixing anti-counterfeiting tags. It improves security performance effectively.

### DESCRIPTION OF FIGURES

FIG. 1 is a main view schematic diagram of a RFID tag in present invention embodiment 1.

FIG. 2 is a side view schematic diagram of RFID tag compound structure in present invention. It is only for describing the structure and positional relation between each layer in a tag. The size, thickness and shape does not have a meaningful characterization.

FIG. 3 is a position schematic diagram of a RFID tag affixing on the surface of a labeled object in the present invention.

Mark description: 100—Label thickness layer, 1—flake folded dipole conductor, 2—Power supply portion conductor, 3—IC Chip, 4—“island”-type compound gasket, 5—surface layer material, 6—Release Paper, 7—Slit, on metal surface object, 8—metal surface of the labeled object, 9—top layer, 10—bottom layer

### DETAILED DESCRIPTION OF APPLICATION EMBODIMENTS

The following is an exemplary embodiment of present invention. It explains in detail, with reference drawings, to make a passive metal surface disturbance-resistant UHF RFID using fragile paper.

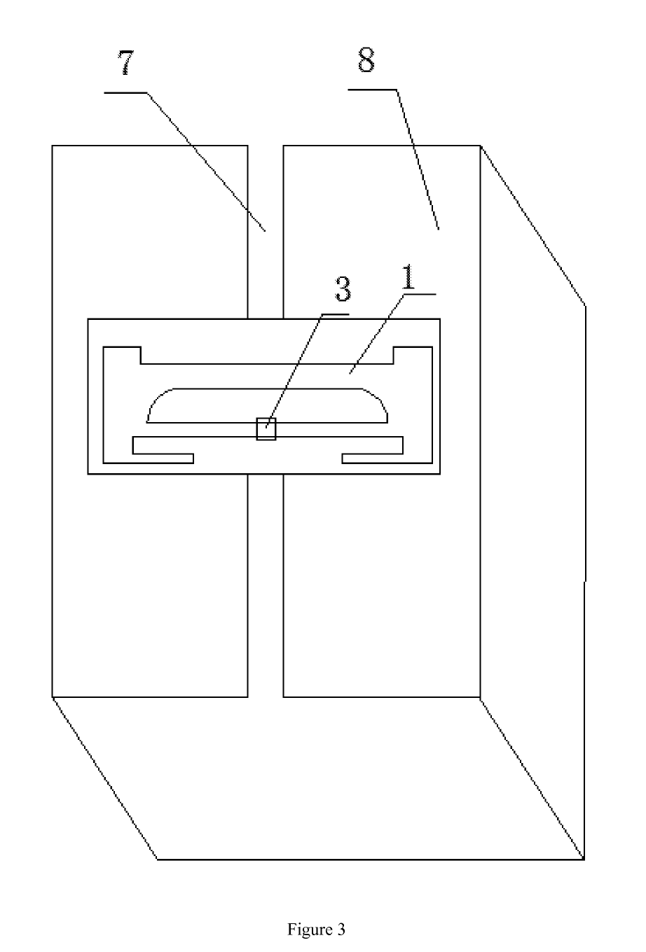

1. Shape and physical characteristics of labeled object: The UHF passive RFID tag affixed to a foils or Aluminized paper printed packing box. There is a slit 7 in the middle on box surface. The tag covers over the slit, as shown in FIG. 3.

2. Expected application result: when open the box, the tag antenna in the fragile paper tag should be destroyed completely.

3. Antenna material: low temperature curing printing silver paste (thickness 3-20 um) (90 degrees Celsius for half an hour) printing screen 280 Mesh

4. Antenna substrate board material: fragile paper, thickness 100 um˜200 um (dielectric constant Er<3), storage temperature 5-40 degrees Celsius, humidity: more than 40%.

5. Dimensions: Rectangular, 20 mm*40 mm, size of “island” type compound gasket 4: Square, 18*18 mm

6. Flip chip bonding uses Sony ACP—BP304E conductive adhesive.

7. IC chip: NXP G2i1

8. A thin layer of security printing paper 6 is compound on surface of the tag. There is a release film layer between paper 6 and the tag.

9. Read range longer than 5-10 cm.

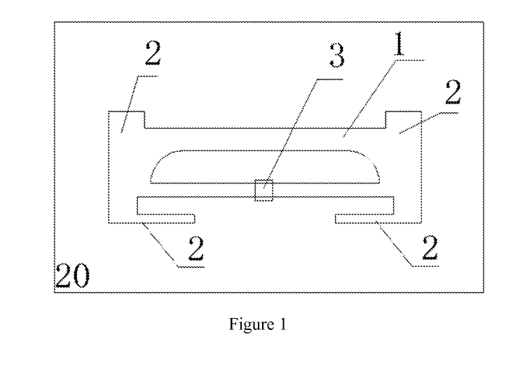

FIG. 1 shows the antenna in this implementation case. The antenna structure design uses flake folded dipole, including the flake folded dipole conducts 1 in center location and power loading conductor 2 in two sides. The described flake folded dipole conductor 1 folds and connects with IC chip 3 making a close loop. There are two pairs of power supply conductors. They connect electrically with the flake folder dipole conductors 1. The power supply conductors are curve power loading poles.

To reduce physical size, in this implementation case, another two pairs of power supply poles 2 are added over the flake folded dipole. And one pair of them is bent designed. The purpose is to reduce the overall antenna area. Actually, work frequency decides the size of dipole. The bent design not only can reduce antenna's characteristics impedance, make a flatter impedance change curve, but also can make working frequency band expandable. At the same time an important function of it is significantly increasing the radar cross section of the label. It's crucial in microwave RFID systems.

Adjust spacing within flake folded dipole conductor loop can change input impedance of antenna. Impedance matching between antenna and tag IC chip can be realized so the maximum energy transmission in and out tag IC chip obtained. In RFID applications, the chip IC input impedance can be any value. It's hard for an antenna design to be the perfect one. Specific spacing parameters of flake folded dipole conductor loop determined by practical needs. In this way a RFID tag's sensitivity and sensing capability improved.

In present implementation case, the bent design of power supply poles can be rectangular right angles, triangle, arch or trapezoid curved. It's not necessary to specify the bending shape in practice.

Optimized selection for mentioned flake folded dipole conductor is rectangular or circle, with horizontal width range for 2˜-50.8 mm and vertical length range 2˜80 mm. It is subject to suit practical needs.

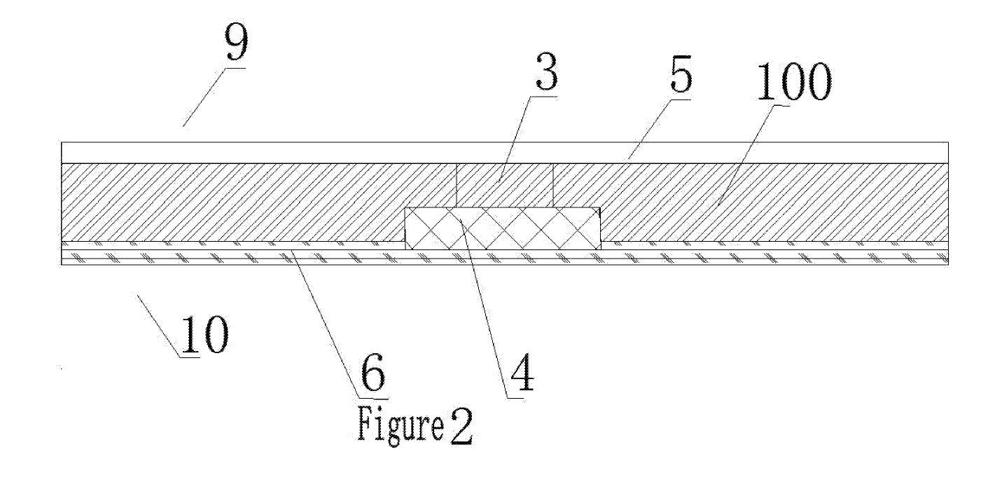

As FIG. 2 shows, under the fragile paper substrate alignment IC chip 3 at the central location overlay is a “island”-type compound gasket 4. Anntena located in spatial structure formed at the central arch. Thickness of mentioned “island”-type compound gasket is in 0.05 mm to 0.3 mm range. When RFID tag is active, remove the bottom release paper 6 and affix the tag on the surface of labeled object as shown in FIG. 3. The antenna formed arch spatial at the center location of IC chip. At the mean time inducted metal surface of labeled object. Make the metal surface of labeled object accessible as part of antenna.

Obtained by the present invention method, RFID tags are compound structured RFID labels, as shown in FIG. 2, successively from bottom to surface including adhesive bottom layer, “island”-type compound gasket 4, fragile paper substrate, folded dipole antenna and IC chip, the adhesive surface layer and surface material 5. Antenna and fragile paper substrate board are integrated firmly. IC chip and antenna electrically connect (in FIG. 2 summered antenna & chip layer, substrate board layer and two layer adhesive layers as the label thickness layer 100). The “island” type compound gasket 4 aligns with the location of chip 3. The size of compound is less than that of fragile paper substrate board. The surface of mentioned object that referred to be identified covered by aluminum-plated paper and the body surface 8 has a slit 7. Affix the entire RFID tag to the identity object surface. Antenna structure is symmetrical about the slit. Tag chip 3 aligns with the slit 7 position. Supply anti-counterfeiting packages, which is obtained by affixing anti-counterfeiting tags to the surface of labeled object package with IC chip 3 aligning with slit 7, Manufacturers put them into products and then just need to seal and active the anti-counterfeiting RFID tags. When consumers open the packages, the RFID labels will be torn up from the slit 7, thus destroying the anti-counterfeiting RFID labels at the same time.

For better practical effect, here are some technical restrictions for the solution, as shown in FIG. 2 side view schematic diagram. Thickness layer 100 of the label consists of substrate board, antenna and adhesive layers. A suitable thickness range is set as 0.05 mm to 1 mm. The mentioned dielectric substrate is made of one layer or multilayers fragile materials. Dielectric constant ranges from 1 to 100. Known from the implementation cases, if the label layer thickness 100 is greater than 1 mm, the label will be easily peeled off the object for re-using due to its thickness. Thus the function of anti-counterfeiting to the label from attachments are stripped on thick so easy to reuse, no security significance. Because of fragile paper's nature that extremely easy to crush, if the layer thickness 100 is less than 0.05 mm, it's hard to build a normal usable RFID tag. Optimized solution of the thickness of RFID antennas and the adhesive layers is 0.2 mm, with the best identifying and anti-counterfeiting results.

1. A method of designing and manufacturing tamper-evident metal-surface-disturbance-resistant UHF RFID tags, characterized in that this method comprised of the following steps:
(1) The tag antenna design using folded dipole antenna form.
(2) Using fragile paper as substrate board for antenna, integrating antenna and fragile paper substrate board securely and firmly.
(3) Placing IC chip in the middle of the power supply portion of folded symmetric dipole antenna to achieve electrical connection between the antenna and the chip.
(4) On the bottom surface of fragile paper substrate overlaying an “island”-type compound gasket, in alignment with the central position of the chip. The size of the compound gasket should be less than or equal to the size of fragile paper substrate, so that the antenna forms an arch spatial structure in the center position of the chip.
(5) Coating the mentioned fragile paper substrate surface with adhesive, then compounding with cover layer material which coated with release fragile film former. The sizes of surface material and adhesive are larger than that of the fragile paper substrate board.

2. Obtained by the method as claimed in claim 1, a tamper-evident metal-surface-disturbance-resistant UHF RFID tag, characterized in that: a compound structured RFID tag. Successively from bottom to surface the compound structured RFID label includes adhesive bottom layer, “island” type compound gasket, fragile paper substrate board, folded dipole antenna & IC chip, adhesive layer and surface material. Antenna integrates with fragile paper substrate board firmly and securely. Chip and antenna are connected electrically. “Island” type compound gasket is in alignment with the central position of IC chip. The size of compound gasket is less than or equal to the size of the fragile paper substrate board.

3. An anti-counterfeiting package, consisting of RFID tags obtained by the method as claimed in claim 1 and metal surface object to be identified, characterized in that: includes RFID tags with compound structures and the labeled objects. The mentioned RFID tags structured successively from bottom to surface as adhesive bottom layer, “island” type compound gasket, fragile paper substrate board, folded dipole antenna & chip, adhesive surface layer and surface material. Antenna is integrated with fragile paper substrate board firmly and securely. Chip and antenna are connected electrically. “Island” type compound gasket is in alignment with the central position of chip. The size of compound gasket is less than or equal to the size of the fragile paper substrate board. The mentioned identically labeled object is covered by foil or aluminum-plated paper and there is a slit on surface of the object. Attach the entire RFID tags to the surface of the object in such a way that the dipole antenna structure of the tag is symmetrical about the slit and the chip is in alignment with the position of the slit.

4. As claimed in claim 2, a tamper-evident metal-surface-disturbance-resistant UHF RFID tag, characterized in that: The mentioned antenna structure design uses flake folded dipole, which including flake folded dipole conducts in center position and power supply conductors in two sides. The described flake folded dipole conductors connects with IC chip and make a close loop. The described power supply pole conductors electrically connect with the flake folded dipole conductors. The power supply conductors are curved.

5. As claimed in claim 4, a tamper-evident metal-surface-disturbance-resistant UHF RFID tag, characterized in that: the mentioned flake folder dipole conductors are rectangular or circle.

6. As claimed in claim 4, a tamper-evident metal-surface-disturbance-resistant UHF RFID tag, characterized in that: the mentioned power supply poles are designed as multiple pairs. Each pair is set symmetrically about the flake folded dipole conductors.

7. As claimed in claim 2, a tamper-evident metal-surface-disturbance-resistant UHF RFID tag, characterized in that: in mentioned antenna layer there is a die-cutting edge line.

8. As claimed in claim 2, a tamper-evident metal-surface-disturbance-resistant UHF RFID tag, characterized in that: On the outside of the mentioned tag surface material, print a straight line as a mark.

9. As claimed in claim 2, a tamper-evident metal-surface-disturbance-resistant UHF RFID tag, characterized in that: print anti-counterfeiting patterns on the inside part of the surface material.

10. As claimed in claim 2, a tamper-evident metal-surface-disturbance-resistant UHF RFID tag, characterized in that: The thickness of the mentioned ‘island’ type compound gasket ranges from 0.05 mm to 0.3 mm.

11. As claimed in claim 2, a tamper-evident metal-surface-disturbance-resistant UHF RFID tag, characterized in that: substrate board, antenna and adhesive layers consists a thickness layer of the tag.

12. As claimed in claim 11, a tamper-evident metal-surface-disturbance-resistant UHF RFID tag, characterized in that: the mentioned thickness layer is 0.2 mm.
